(19) United States
(12) Patent Application Publication
(10) Pub. No.: US 2011/0280023 A1
(43) Pub. Date: Nov. 17, 2011

(54) LENS MODULE FOR LED LAMP

(76) Inventors: Ching-Chuan LEE, Sindian City (TW); Yun-Yuan YEH, Sindian City (TW)

(21) Appl. No.: 12/778,497

(22) Filed: May 12, 2010

(51) Int. Cl. F21V 5/00

(52) U.S. Cl. 362/338; 362/326

(57) ABSTRACT

The present invention relates to a lens module for LED lamp, comprises a base installed with a first chamber and a second chamber opposite to the first chamber, the first chamber is able to be connected with a substrate, and at least one LED module is installed on the substrate; a first lens; and a second lens. With the mentioned structure, lights emitted by LED modules can be refracted by the first lens and the second lens for achieving the purpose of unifying lights. Moreover, the base, the first lens and the second lens are made of transparent material and formed with an injection molding means for lowering the production cost.

### BACKGROUND OF THE INVENTION

1. Field of the Invention

The present invention relates to a lens module, especially to a lens module used in a LED lamp and having a first lens and a second lens respectively installed with a plurality of convex pattern structures for unifying lights emitted by LED modules.

2. Description of Related Art

Generally, a LED lamp is often installed with at least one lens, not only for sealing the lamp but also for preventing light emitting diodes from being in contact with external air, and also for scattering lights emitted by the light emitting diodes.

The lens for a conventional LED lamp can be flat or in a ball shape, the ball-shaped lens is often used in a LED bulb and is detachable from a main body of the lamp, so as to scatter the lights emitted by the light emitting diodes with a maximum angle. The flat lens has an advantage of occupying less space so is often used in an illumination device occupying less space, e.g. a flashlight or night lamp. But for a flat lens having large size, especially larger than 70 mm, it is hard to be made with an injection molding means due to the large volume; and for an injection molding with lens, light distribution would be effected as long as the surface is less than perfect. So the application of large-size flat lens is limited and shall be improved.

For improving the mentioned disadvantages of lens module for conventional LED lamp, the present invention provides a lens module for LED lamp.

### SUMMARY OF THE INVENTION

One primary object of the present invention is to provide a lens module for LED lamp, in which a base, a first lens and a second lens are made of transparent insulation material and formed with an injection molding means for lowering production cost and for manufacturing large-size lens modules.

Another object of the present invention is to provide a lens module for LED lamp, in which one end of a first chamber is formed with a ball-shaped surface for gathering lights emitted by LED modules so as to increase the brightness.

One another object of the present invention is to provide a lens module for LED lamp, in which a surface of a first lens is installed with a plurality of convex pattern structures for unifying lights emitted by LED modules.

Still one another object of the present invention is to provide a lens module for LED lamp, in which a surface of a second lens is installed with a plurality of convex pattern structures for unifying lights emitted by LED modules.

For achieving the objects mentioned above, the present invention provides a lens module for LED lamp, comprises a base installed with a first chamber and a second chamber opposite to the first chamber, the first chamber is able to be connected with a substrate, and at least one LED module is installed on the substrate; a first lens disposed at the bottom of the second chamber; and a second lens disposed at the top of the second chamber, such that lights emitted by the LED modules can be refracted by the first lens and the second lens for achieving the purpose of unifying lights.

### BRIEF DESCRIPTION OF THE DRAWINGS

FIG. 1 is a schematic rear view illustrating the lens module for LED lamp of one preferred embodiment of the present invention being separated from a substrate;

FIG. 2 is a schematic front view illustrating the lens module for LED lamp of one preferred embodiment of the present invention being separated from the substrate;

FIG. 3 is a schematic cross sectional view illustrating the lens module for LED lamp of one preferred embodiment of the present invention being assembled with the substrate.

### DETAILED DESCRIPTION OF THE PREFERRED EMBODIMENT

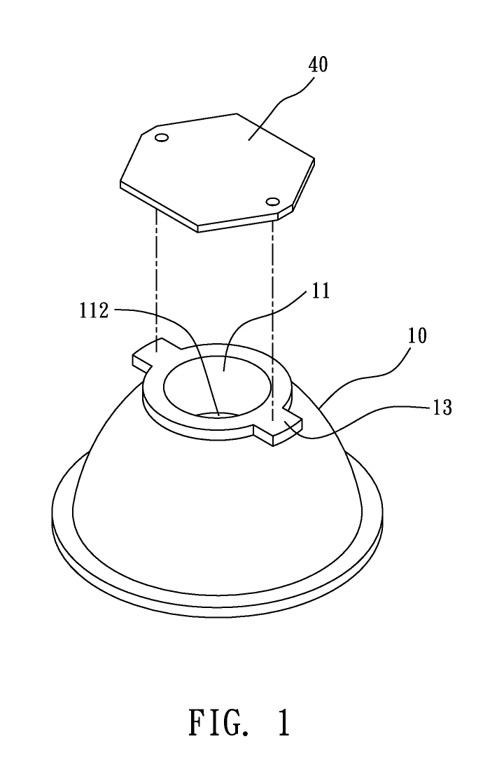

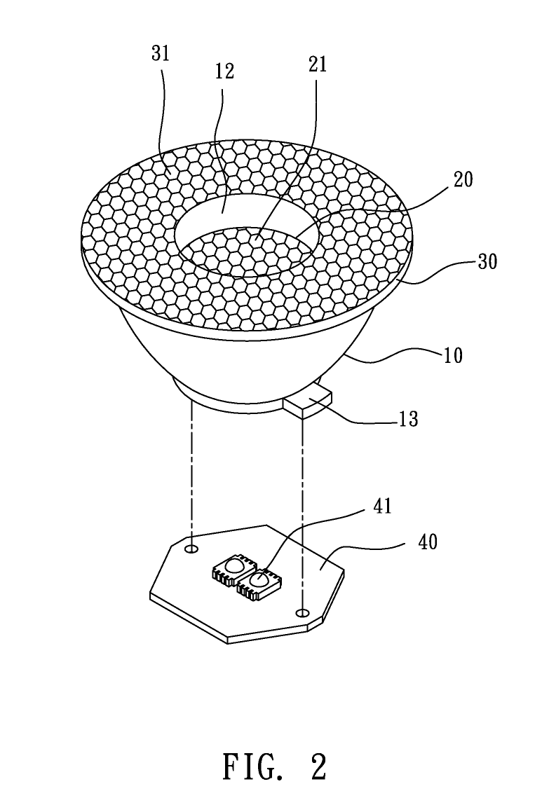

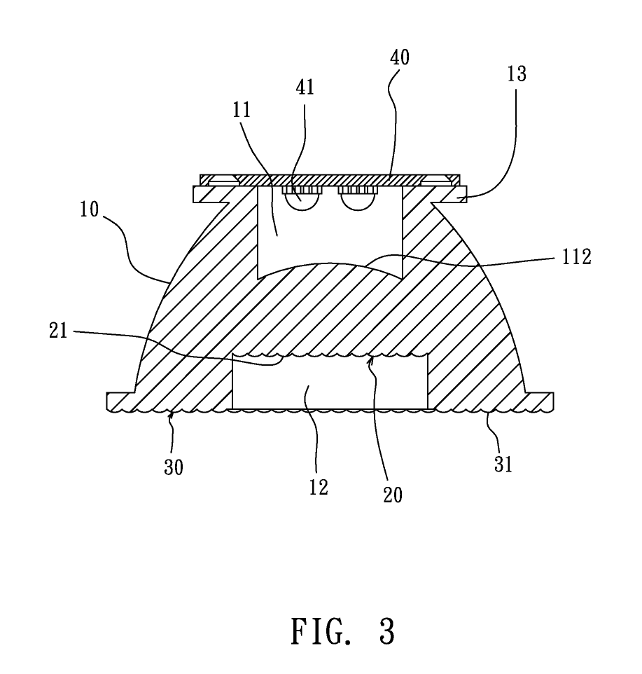

Referring from FIG. 1 to FIG. 3, wherein FIG. 1 is a schematic rear view illustrating the lens module for LED lamp of one preferred embodiment of the present invention being separated from a substrate; FIG. 2 is a schematic front view illustrating the lens module for LED lamp of one preferred embodiment of the present invention being separated from the substrate; FIG. 3 is a schematic cross sectional view illustrating the lens module for LED lamp of one preferred embodiment of the present invention being assembled with the substrate.

As shown in figures, the lens module for LED lamp provided by the present invention, which is suitable to be installed in a LED lamp, comprises: a base 10; a first lens 20 and a second lens 30.

The base 10 is made of transparent or semi-transparent material and is formed through an injection molding means, wherein the transparent material is, e.g. but not limited to, transparent PC or silicon, the shape thereof is, e.g. but not limited to, in a cone shape, and a first chamber 11 and a second chamber 12 opposite to the first chamber 11 are installed thereon; wherein the first chamber 11 is able to be connected with a substrate 40 installed with at least one LED module 41, the quantity thereof is between one to four, in this embodiment two LED modules 41 are adopted for illustration and not served as a limitation. Each LED module 41 is further provided with at least a light emitting diode and a driver thereof (not shown), the light emitting diode and said driver are not the features of the present invention, therefore no further illustration is provided.

In the present invention, the first chamber 11 and the second chamber 12 are installed on the base 10 for not only saving the material of which the base 10 is made but also for a final product thereof being easily formed and the illumination effect is kept.

Moreover, two ends of the first chamber 11 are respectively installed with an ear portion 13 for allowing the substrate 40 being fastened and facilitating the removal operation performed by a pin (not shown) during the injection molding. An end of the first chamber 11 close to the second chamber 12 is further formed with a ball-shaped surface 112 serving to gather lights emitted by the LED modules 41 for increasing the brightness.

The first lens 20 is disposed at the bottom of the second chamber 12, and is made of transparent or semi-transparent material and formed on the bottom of the second chamber 12 with an injection molding means, and the first lens 20 is further installed with a plurality of convex pattern structures 21, the shape thereof are e.g. but not limited to honeycomb shape, such that the lights emitted by the LED modules 41 can be unified.

The second lens 30 is disposed at the top of the second chamber 12, and is made of transparent or semi-transparent material and formed on the top of the second chamber 12 with an injection molding means. The second lens 30 is further installed with a plurality of convex pattern structures 31, the shapes thereof are e.g. but not limited to honeycomb shape, such that the lights emitted by the LED modules 41 can be further unified.

The base, the first lens and the second lens of the present invention are designed with respect to the operation of injection molding, so when being made of transparent or semi-transparent material with the injection molding means, the optical requirement is still met, so the production cost is lowered; and the first lens 20 and the second lens 30 with sizes larger than 70 mm can be manufactured through the injection molding means as long as proper large-size molds are available.

As shown in FIG. 3, after the LED module is processed with the injection molding, the base 10 is provided with the first chamber 11 and the second chamber 12, and the first lens 20 is formed at the bottom of the second chamber 12 and is installed with the plural convex pattern structures 21; the second lens 30 is formed on the top of the second chamber 12 and is installed with the plural convex pattern structures 31. Meanwhile, according to actual illumination requirements, the substrate 40 can be altered or modified; for example, if the illumination requirement is high, a substrate 40 having three or four LED modules 41 can be adopted, when the illumination requirement is low, a substrate 40 having one or two LED modules can be adopted, and the substrate 40 is fastened on the ear portions 13 through fastening units, e.g. screws. As such, the lights emitted by the LED modules 41 are firstly gathered by the ball-shaped surface 112 for increasing the brightness, then are processed with a first refraction through the convex pattern structures 21 of the first lens 20 and a second refraction through the convex pattern structures 31 of the second lens 30 so as to further unify the lights. Thus, the lens module for LED lamp provided by the present invention is novel compared to conventional lens module for LED lamp.

Comparing to conventional lens module for LED lamp, the lens module for LED lamp provided by the present invention has following advantages: 1. the base, the first lens and the second lens are made of transparent insulation material and formed through an injection molding means so as to lower production cost; 2. one end of the first chamber is formed with a ball-shaped surface for gathering lights emitted by the LED modules so as to increase the brightness; 3. surfaces of the first lens and the second lens are respectively installed with plural convex pattern structures for unifying the lights emitted by the LED module; 4. according to the illumination requirement, a substrate 40 with different quantity of LED modules 41 can be adopted; and 5. a large-size lens module is able to be manufactured. Thus, the lens module for LED lamp provided by the present invention is novel compared to conventional lens module for LED lamp.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lens module for LED lamp, comprising:
a base installed with a first chamber and a second chamber opposite to said first chamber, said first chamber being connected with a substrate, and at least one LED module being installed on said substrate;
a first lens disposed at the bottom of said second chamber; and
a second lens disposed at the top of said second chamber, such that lights emitted by said LED modules being refracted by said first lens and said second lens for unifying lights.

2. The lens module for LED lamp as claimed in claim 1, wherein said base, said first lens and said second lens are made of transparent or semi-transparent material and formed with an injection molding means, wherein said transparent material is transparent PC or silicon.

3. The lens module for LED lamp as claimed in claim 1, wherein two ends of said first chamber are respectively installed with an ear portion for allowing said substrate being fastened and facilitating the removal operation performed by a pin during the injection molding.

4. The lens module for LED lamp as claimed in claim 1, wherein an end of said first chamber close to said second chamber is formed with a ball-shaped surface for gathering lights emitted by said LED modules so as to increase the brightness.

5. The lens module for LED lamp as claimed in claim 4, wherein a surface of said first lens is further installed with a plurality of convex pattern structures for unifying lights emitted by said LED modules.

6. The lens module for LED lamp as claimed in claim 5, wherein a surface of said second lens is further installed with a plurality of convex pattern structures for further unifying lights emitted by said LED modules.

7. The lens module for LED lamp as claimed in claim 1, wherein the quantity of said LED module is one to four.
